(19) United States
(12) Patent Application Publication
(10) Pub. No.: US 2002/0007325 A1
(43) Pub. Date: Jan. 17, 2002

(54) IT system

(76) Inventor: Isao Tomon, Chiba-Shi (JP)

Correspondence Address: Edward G. Greive, Renner, Kenner, Greive, Bobak, Tayler & Weber, Fourth Floor, First National Tower, Akron, OH, 44308, US

(21) Appl. No.: 09/727,961

(22) Filed: Dec. 1, 2000

(30) Foreign Application Priority Data
Jul. 11, 2000 (JP) 2000-210303

(51) Int. Cl. G06F 17/60

(52) U.S. Cl. 705/28

(57) ABSTRACT

An object of the present invention is to provide an IT system capable of easily and reliably transmitting/receiving data.

An IT system includes: an ID issue and management engine for issuing and managing an RFID having a unified data format; an S-label recording device for recording various kinds of data including an RFID on a later-described S-label; a scanner for reading data recorded on the S-label; a computer device for fetching data read by the scanner; a server connected to the computer device through a network; and a mobile communication terminal for performing wireless communication with respect to the server. In order to utilize the S-label on which the RFID having a unified data format is recorded for transmission/reception of various kinds of information, data formats exchanged on a network can be unified, which facilitates construction and change of the IT system.

### CROSS REFERENCE TO RELATED APPLICATIONS

The present application claims priority on Paris Convention on the basis of Japanese Patent Application Laid-Open No. 2000-210303 filed on Jul. 11, 2000 in Japan.

### BACKGROUND OF THE INVENTION

(i) Field of the Invention

The present invention relates to an IT (Information Technology) system for issuing unified IDs to manage commercial goods or services.

(ii) Related Background Art

Nowadays, there are increased examples of construction of an IT system such that internet or corporate networks are utilized to transmit/receive information between different departments.

FIG. 1 is a schematic structural view of this kind of conventional IT system and shows an example where a plurality of departments in a company transmit/receive information through a corporate network. As shown in the drawing, it is general, in the prior art, that a computer 1 provided in each of departments such as an accounting department, a material department, a marketing department, a branch and a warehouse, and a center 2 having a server function transmit/receive information through a corporate network 3.

Generally, the center 2 has a database 4. In order to newly register data in this database 4, there is required a troublesome procedure such that the computer 1 in each department inputs data in a determined format and the center 2 checks and thereafter registers the inputted information.

Further, since formats of data to be registered in the database 4 or conformations of the network are not unified in particular in the prior art, everything must be determined to construct the network, so that the construction of the IT system therefore takes a large amount of cost and time. In particular, there is a problem that an initial cost, a development cost and a maintenance cost become enormous as the scale of the system increases.

Additionally, when different types of computers are connected to the network, there is also a problem that the compatibility of data is lowered, which makes it difficult to communize data.

Moreover, the scale of the once constructed network cannot be easily increased, and the operation of the entire system becomes unstable, so that reliability tends to lower.

### SUMMARY OF THE INVENTION

It is, therefore, an object of the present invention-to provide an IT system which can easily and reliably transmit/receive data.

To this end, an IT (information Technology) system comprises:

issuing and managing means for issuing and managing an RFID (Radio Frequency ID) whose data format is unified;

an S-label on which the issued RFID is recorded;

reading means for reading data including the RFID recorded on the S-label;

authenticating means for authenticating the RFID read by the reading means; and

service providing means for providing various kinds of services to an owner of the S-label based on the data read by the reading means, when authentication by the authenticating means achieves success.

According to the present invention, information is transmitted/received by utilizing an S-label on which an RFID (Radio Frequency ID) is recorded having the unified data format, so that construction and change of the network are facilitated, which can greatly reduce the initial cost and the development time required for construction of the network.

Moreover, since middleware for connecting to the internet is provided, it is possible to have access to a specific site on the internet by a simple procedure based on the S-label so that various services can be available.

Further, since the S-label can be utilized as a user authenticating technique with the high confidentiality, it can be used for various purposes such as registry, updating and reference of a database, commercial goods management, provision of various services and others.

In addition, since information on the S-label is transmitted/received through the internet, information on the S-label can be extensively shared irrespective of countries and areas.

### BRIEF DESCRIPTION OF THE DRAWINGS

FIG. 1 is a schematic structural view showing this type of a prior art IT system;

FIG. 2 is a block diagram showing a schematic configuration of an embodiment of an IT system according to the present invention;

FIG. 3 is an outline view showing an S-label;

FIG. 4 is a block diagram showing an internal structure of an RFID chip 21;

FIG. 5 is a view showing an example of a data format of information stored in a PROM 34;

FIG. 6 is an electrical characteristic view of the S-label and a scanner 13;

FIG. 7 is an electrical characteristic view of an antenna for the S-label;

FIG. 8 is a flowchart showing a processing procedure of the IT system illustrated in FIG. 2;

FIG. 9 is a block diagram showing a schematic configuration of an IT system aiming at registry, updating and distribution of a database;

FIG. 10 is a block diagram showing a schematic structure of the IT system aiming at tracking of a delivery;

FIG. 11 is a block diagram showing a schematic structure of an IT system aiming at issue of a worldwide ID and registry, reference and distribution of a database;

FIG. 12 is a block diagram showing a schematic structure of an IT system aiming at management of entering and dispatching from warehouse and inventory;

FIG. 13 is a block diagram showing a schematic structure of an IT system aiming at reservation and ticketless; and

FIG. 14 is a block diagram showing a schematic structure of an IT system aiming at management of real/false articles and history.

### DESCRIPTION OF THE PREFERRED EMBODIMENTS

An IT system according to the present invention will now be concretely described hereinafter with reference to the accompanying drawings.

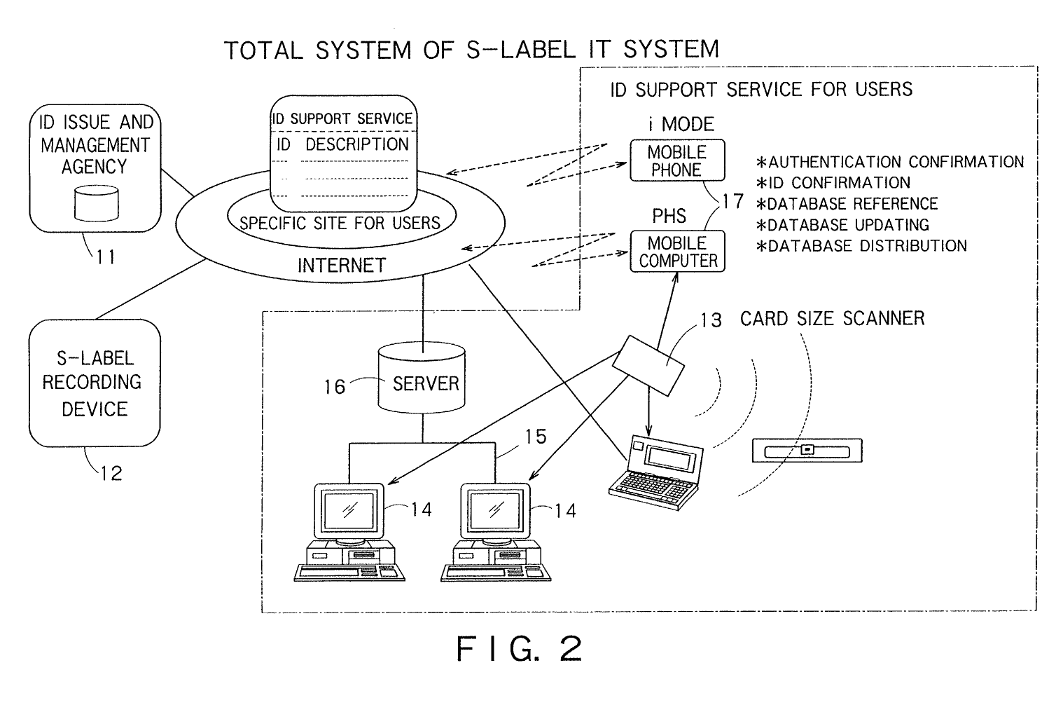

FIG. 2 is a block diagram showing a schematic structure of an embodiment of an IT system according to the present invention. The IT system illustrated in FIG. 2 comprises: an ID issue and management engine (issuing and management means) 11 for issuing and managing an RFID (Radio Frequency ID) whose data format is unified; an S-label recording device 12 for recording various kinds of data including the RFID on the S-label which will be described later; a scanner (reading means) 13 for reading data stored on the S-label; a computer device (transmitting means) 14 for fetching data read by a scanner 13; a server 16 connected to the computer device 14 through a network 15; and a mobile communication terminal 17 for performing wireless communication with the server 16.

Although the conformation of the network is no object, an example of transmission/reception of data on the internet will be described hereinafter.

The ID issue and management engine 11, the S-label recording device 12, and the server 16 connect to the internet through a public line such as a telephone line or a dedicated line, and the mobile communication terminal 17 connects to the internet through a radio line.

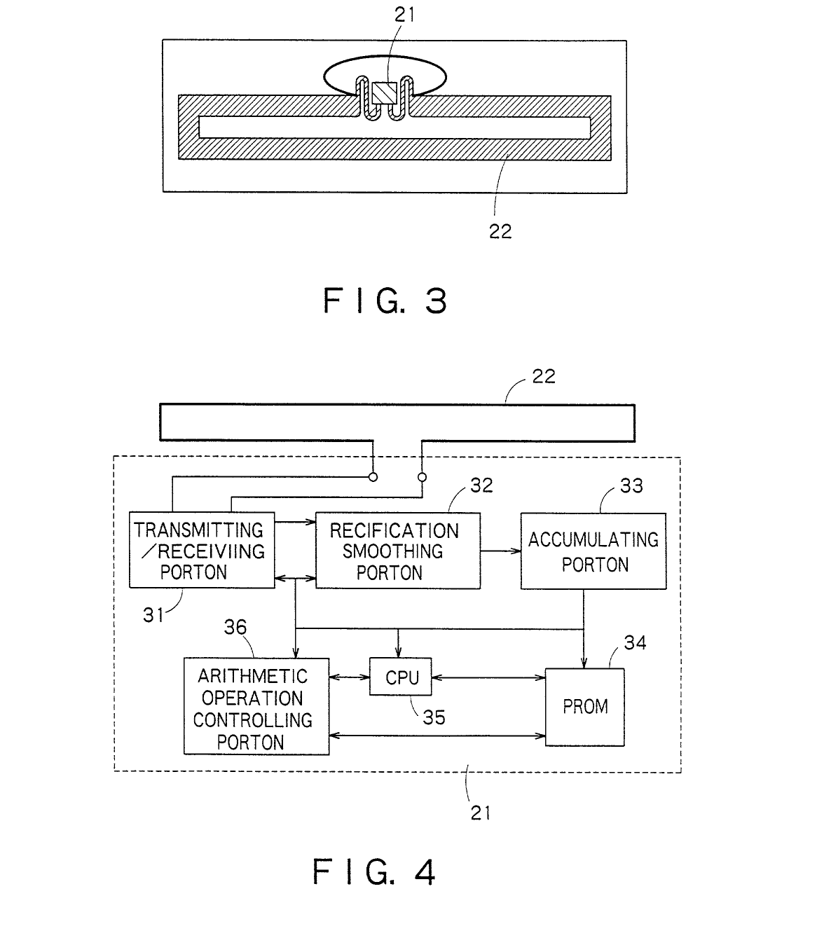

FIG. 3 is an outline view of an S-label. The S-label shown in FIG. 3 is a structure that an RFID chip 21 for transmitting various kinds of data including an RFID in the wireless manner and a plate-like antenna 22 so arranged as to surround the RFID chip 21 are adhered to a support body 23 such as, e.g., paper.

FIG. 4 is a block diagram showing the internal structure of the RFID chip 21. The RFID chip 21 shown in FIG. 4 includes: a transmitting/receiving portion (an electric wave transmitting portion) 31; a rectification smoothing portion 32; an accumulating portion 33; a PROM (an RFID storage portion, a user storage portion) 34; a CPU 35; and an arithmetic calculation controlling portion 36. The transmitting/receiving portion 31 modulates information stored in the PROM 34 to be transmitted and also detects an electric wave received by the antenna. The rectification smoothing portion 32 converts a signal detected by the transmitting/receiving portion 31 into a direct-current voltage or a direct-current current. The accumulating portion 33 accumulates the electrical energy obtained by the received electric wave and utilizes it as the electrical energy for radio wave transmission.

The CPU 35, as well as the arithmetic operation controlling portion 36, controls the entire RFID chip 21. The PROM 34 is made up of a non-volatile semiconductor memory and the like and stores various kinds of information such as an RFID.

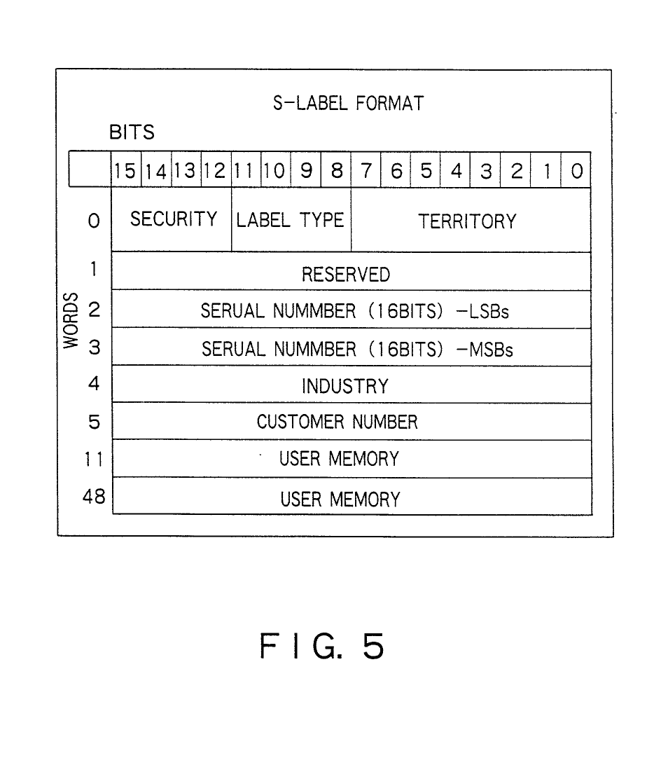

FIG. 5 shows an example of a data format of information stored in the PROM 34. In the example of FIG. 5, security information is stored in the 15th to 12th bits in the 0th word; label type information is stored, in the 11th to 8th bits of the same; and region information is stored, in the 7th to 0th bits of the same. Further, serial numbers consisting of 32 bits representing an RFID are stored in the second and third words, and a customer number is stored in the 5th word. Moreover, 6th to 63rd words are used for storing therein various kinds of information as a user memory.

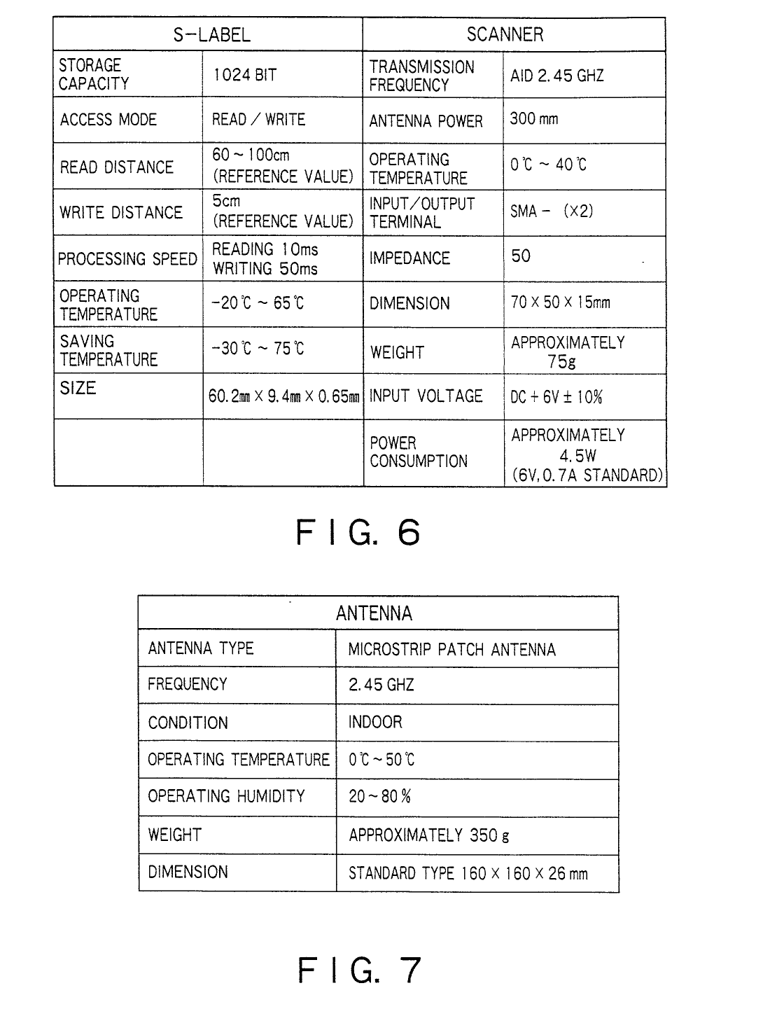

FIG. 6 is an electrical characteristic view of the S-label and a scanner 13, and FIG. 7 is an electrical characteristic view of the antenna for the S-label. As shown in the drawings, the S-label has a data capacity with which 1024 bits can be read. Although an example in which the PROM 34 is used is shown in FIG. 4, if a RAM or an EEPROM is included in the RFID chip 21, data can be overwritten.

On the other hand, the scanner 13 has, e.g., a mobile card size and can read data in the S-label in the non-contact manner by using an electric wave of 2.45 GHz. A distance between the scanner 13 and the S-label is set to approximately 60 to 100 cm.

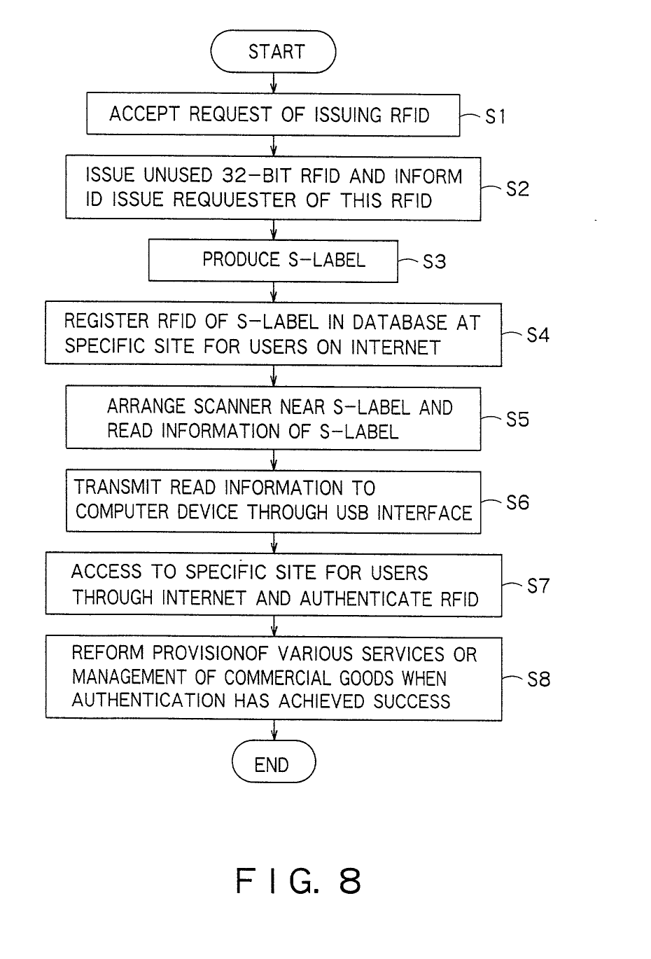

FIG. 8 is a flowchart showing the processing procedure of the IT system illustrated in FIG. 2. The operation of the IT system shown in FIG. 2 will be described hereinafter with reference to this flowchart.

Upon being requested to issue an RFID from an ID issue requester (step S1), the ID issue and management agency 11 issues an unused RFID of 32 bits and informs the ID issue requester of the RFID (step S2).

The ID issue requester produces an S-label whose shape is the same as that in FIG. 3 in the S-label recording device 12 (step S3) and registers the RFID of the produced S-label in a database existing in a specific site for users on the internet (step S4).

The produced S-label can be used for various purposes. For example, it can be utilized as a tag for managing commercial goods or for authenticating individuals when it is attached on a business card or an IC card. When used as a tag, commercial good information is recorded in a user memory in the RFID chip 21. When used for authenticating individuals, personal information such as a name or a birth date of a user is recorded in the user memory in the RFID chip 21.

After producing the S-label, if the information recorded on the S-label must be read, the scanner 13 is arranged near the S-label in order to read the information on the S-label (step S5). The scanner 13 of this embodiment is provided with a USB (Universal Serial Bus) interface function so that the read information is transferred to the computer device 14 via the USB interface (step S6).

The computer device 14 which has received the information on the S-label has access to a specific site for users through the internet and authenticates the RFID (step S7). As a result, if authentication achieves success, provision of various kinds of services or management of commercial goods is carried out (step S8). As a specific example of provision of services, there are reference, updating and distribution of a database. Further, as management of commercial goods, there are provision of detailed information of a commercial good with the S-label or confirmation of inventory.

As the computer device 14 for receiving data read by the scanner 13, there are included an electronic notebook, a notebook computer, the mobile communication terminal 17 such as a mobile phone, or an electric appliance having a communication function as well as a stationary computer.

For example, in case of using a mobile phone, if the mobile phone and the scanner 13 have the interface for enabling transmission/reception data to/from each other, for example, if the mobile phone and the scanner 13 have an infrared data communication function complying with Blue Tooth, data read-by the scanner 13 may be transmitted to the mobile phone by infrared data communication and an access may be thereafter made to a user-oriented specific site on the internet from the mobile phone through the wireless line.

In addition, if the mobile phone and the scanner 13 can not directly transmit/receive data to/from each other, data may be temporarily transmitted from the scanner 13 to the computer device 14 and that data may be transmitted from the computer device 14 to the mobile phone. Subsequently, an access may be made to a user-oriented specific site on the internet from the mobile phone.

The step S7 in FIG. 8 corresponds to authenticating means and the step S8 corresponds to service providing means.

As described above, in this embodiment, since the S-label on which the RFID having an unified data format is utilized for transmission/reception of various kinds of information, the data format exchanged on the network 15 can be unified, which facilitates construction and change of the IT system. In addition, since management of the RFID is uniformly carried out, management of commercial goods/services can be relatively easily performed in extensive area/regions, and the security function can be also improved.

Moreover, since the scanner 13 for reading information on the S-label has a card size, it can be easily carried and the cost for manufacturing the scanner 13 can be reduced. The S-label can be utilized for various purposes/applications.

Furthermore, since the scanner 13 can read information on the S-label in the non-contact mode, which facilitates handling and hardly causes physical damages, thereby improving the usability. Additionally, since information on a plurality of S-labels can be substantially simultaneously read, the S-label is suitable for usage in a job site where quickness is required such as a checkout counter.

In addition, since middleware for connecting to the internet is provided, information read by the scanner 13 can be transmitted to a specific site for users on the internet by the simple procedure, and this site can be utilized for provision of various kinds of information or management of commercial goods. In particular, in case of connecting to the internet, if it is preset that an access can be made to a specific site for users on the internet by no procedure, any person who is unfamiliar with the operation of the computer device 14 can accept provision of various services at a specific site.

Moreover, taking into consideration that examples of connection to the internet by using the mobile communication terminal 17 such as a mobile phone are recently increasing, information on the S-label read by the scanner 13 can be transmitted to a specific site for users on the internet through the mobile communication terminal 17, and information of the S-label can be hence utilized in a mobile environment.

As a business conformation for providing the S-label to a user, there can be considered a purchase mode such that a user purchases the S-label and a rental mode such that the S-label is lent out to a user.

Although both the purchase mode and the rental mode have the same available service content, the S-label is lent out on the monthly basis in case of the rental mode. Specifically, a contract base rate is set at the time of contract in accordance with the content of the information service. Also, a master registry fee and an access fee in case of accepting provision of information by having access to a site may be separately set.

A market area that the IT system aims at includes, for example, (1) an SCM (Software Configuration Management) system in the apparel business, (2) a physical distribution management system which centers on a truck operation/management and a tracking system, (3) a physical distribution management system which centers on entering and dispatching from warehouse, inventory/stocktaking management, (4) a freshness management system for goods, (5) a real and false management/history management system for goods, (6) a management system in the laundry business, (7) an extensive personal authentication management system, and (8) a ticketless system for reservation and admission.

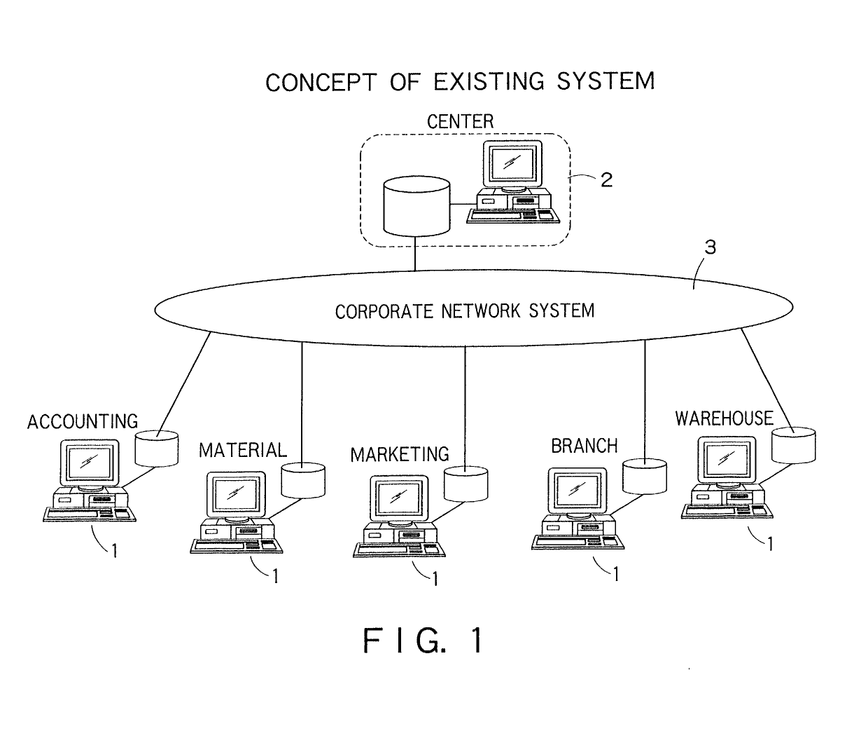

Specific examples of the IT system illustrated in FIG. 1 will now be described hereinafter.

### FIRST CONCRETE EXAMPLE

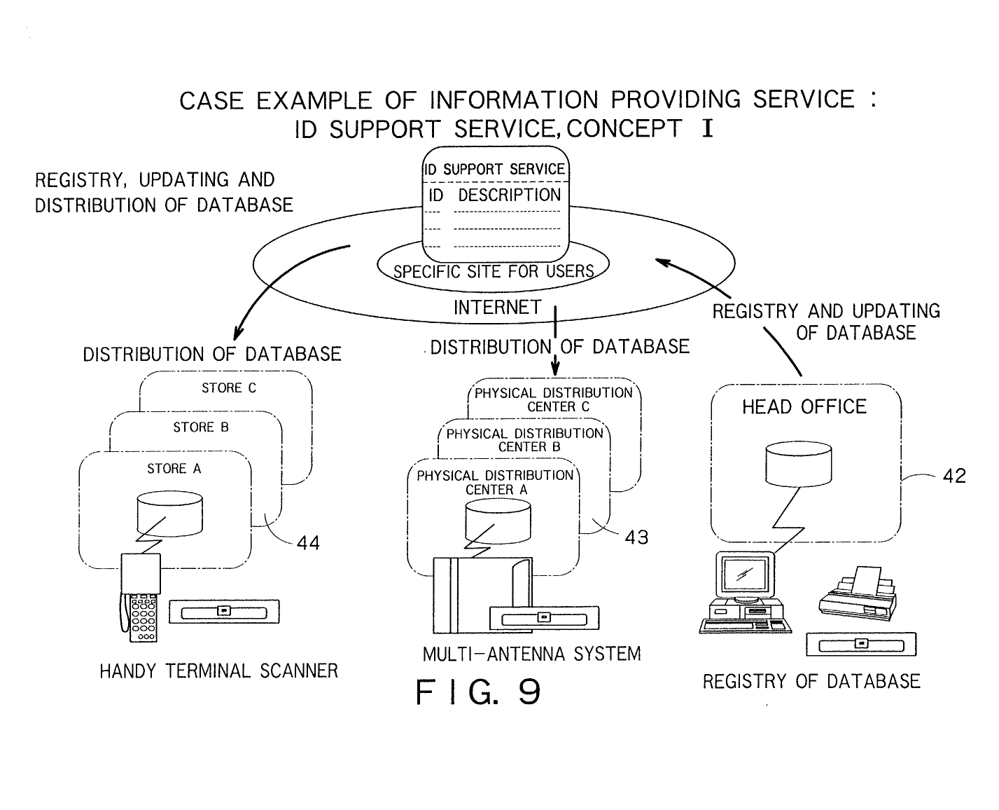

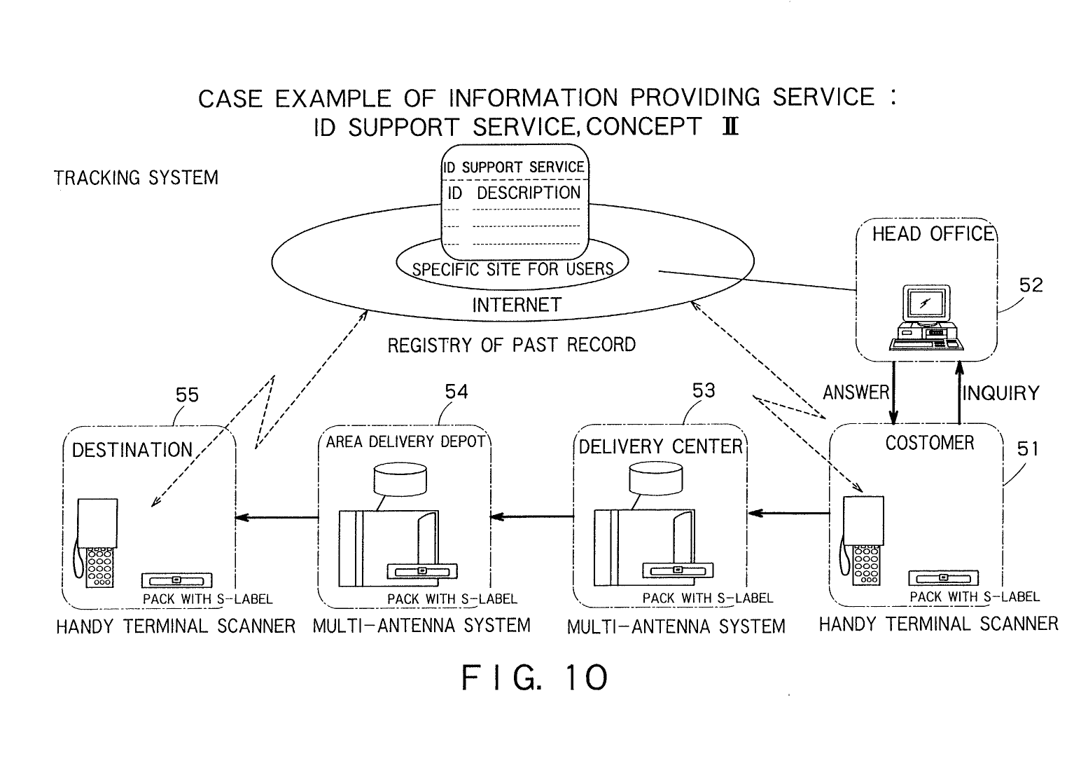

FIG. 9 is a block diagram showing a schematic structure of an IT system aiming at registry, updating and distribution of a database. The IT system in FIG. 9 includes: a head office 42 for carrying out registry in a database 41; physical distribution centers 43 accepting distribution from the database 41; and stores 44 which similarly accept distribution from the database 41. The database 41 is provided at a specific site for users on the internet, and the head office 42, the physical distribution centers 43 and the stores 44 respectively connect to the internet to have access to the database 41.

Commercial goods or services registered in the database 41 have S-labels attached thereto in advance. If the head office 42 registers a new good or service, information on the S-label is read by the scanner 13 and the read information is registered on the database 41 through the internet. Further, if the registered goods or the contents of the services are to be changed, the head office 42 updates the database 41 through the internet.

The physical distribution centers 43 and the stores 44 can make reference to the latest database 41 by having access to a specific site for users on the internet. That is, the specific site for users concentrates/subrogates the database management for the physical distribution centers 43 and the stores 44, and the physical distribution centers 43 and the stores 44 do not need to have the database on their own account, which greatly reduces the system cost. In particular, the cost reduction effect increases as a number of the physical distribution centers 43 or the stores 44 is large and a number of registered goods or services is large.

### SECOND CONCRETE EXAMPLE

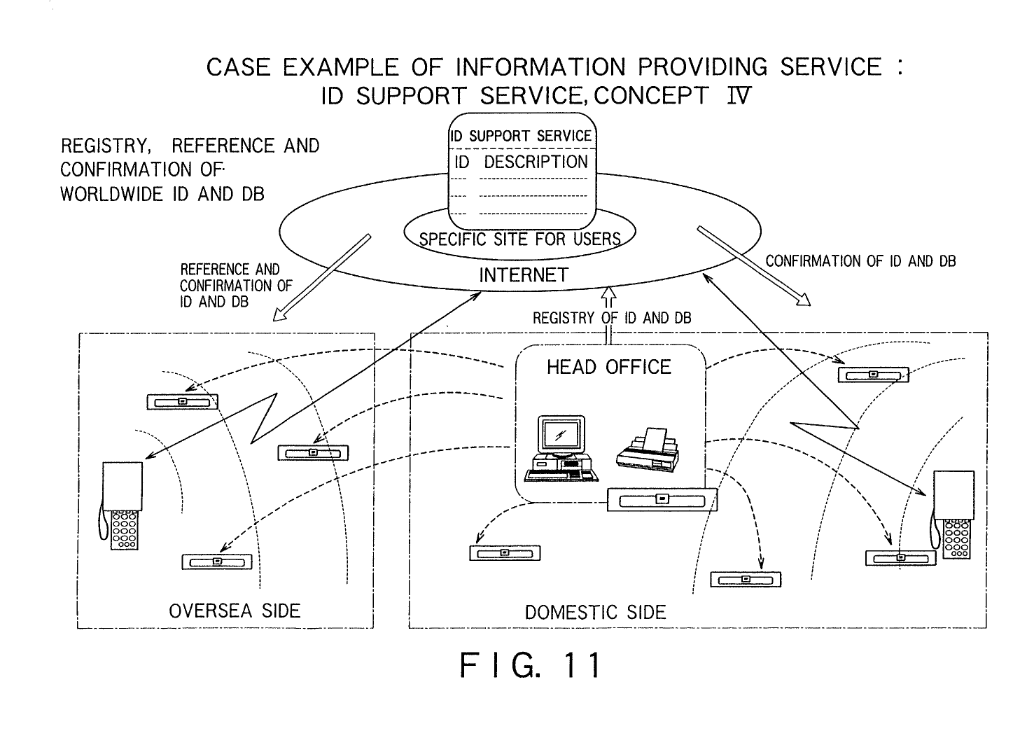

FIG. 10 is a block diagram showing a schematic structure of an IT system aiming at tracking of a delivery. The IT system in FIG. 10 transmits/receives information through the internet between a customer 51 who makes an offer of a good, a head office 52 for accepting inquiries from the customer 51, a delivery center 53, an area delivery depot 54 and a destination 55.

When the customer 51 makes an offer of a good, the S-label of the good is read by the scanner 13 and the read information is transmitted to a specific site for users on the internet through the computer device 14.

When the head office 52 confirms that there was an order from the customer 51 by having access to the specific site for users, it instructs delivery of the good. Further, when the customer 51 makes inquiries about a delivery status of the good, the head office 52 has access to the specific site for users to confirm the delivery status and informs the customer of a result of confirmation.

When the good to be delivered to the customer 51 arrives, the delivery center 53 and the area delivery depot 54 respectively read the S-label of that good by the scanner 13 and transmit the read information to the specific site for users together with information such as a delivery expected date. The processing by the delivery center 53 and the area delivery depot 54 corresponds to first transmitting means.

Further, when a home delivery service supplier and the like delivers the good to a destination specified by the customer 51, the S-label of that good is read by the scanner 13 before handing that good, and the read information is transmitted to the specific site for users. When the head center 52 confirms that the good has arrived to the destination by having access to the specific site for users, it informs the customer 51 of this arrival. The processing by the home delivery service supplier and the like corresponds to second transmitting means and the processing by the head office 52 corresponds to delivery status providing means.

As described above, in this concrete example, since the S-label on the good is read by the scanner 13 in the delivery center 53 or the area delivery depot 54 and the like and the read information is transmitted to the specific site for users on the internet, the user can be informed of the delivery status of the good in real time and in detail.

### THIRD CONCRETE EXAMPLE

FIG. 11 is a block diagram showing a specific structure of an IT system aiming at issue of a worldwide ID and registry, reference and distribution of a database. In the IT system depicted in FIG. 11, a head office 61 is located in, e.g., Japan (any country other than Japan is available) and an S-label is attached to each of various goods or services in Japan to be distributed. Similarly, an S-label is attached to each of various goods or services overseas to be distributed. An RFID having a unified data format such as shown in FIG. 5 is recorded on each of these S-label.

Further, a database 62 for uniformly managing information recorded on the S-label of each good or service is provided at a specific site for users on the internet. When people around the world, however, have access to this database 61, the communication line may burst. The database 61 can be, therefore, divided into multiple parts or the databases 61 having the same content can be provided at a plurality of sites throughout the world.

As described above, in this concrete example, since the unified S-label is given to goods or services distributed throughout the world, management of goods or registry, reference and distribution of the database 61 can be performed by the simple procedure by reading information on the S-label by the scanner 13 and transmitting the read information to the specific site for users on the internet.

### FOURTH CONCRETE EXAMPLE

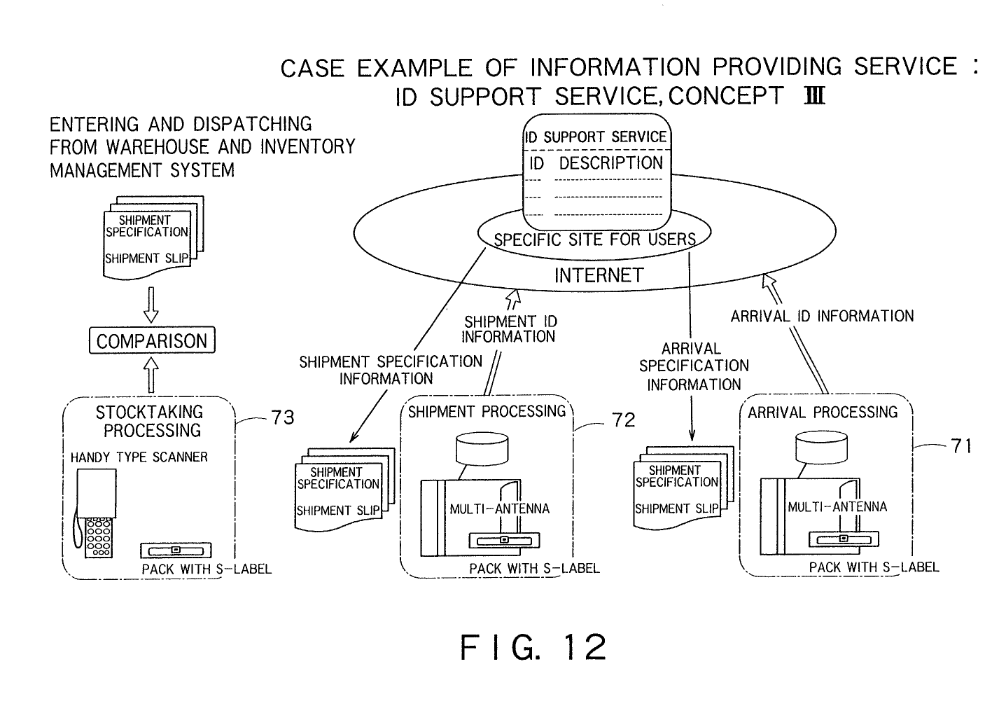

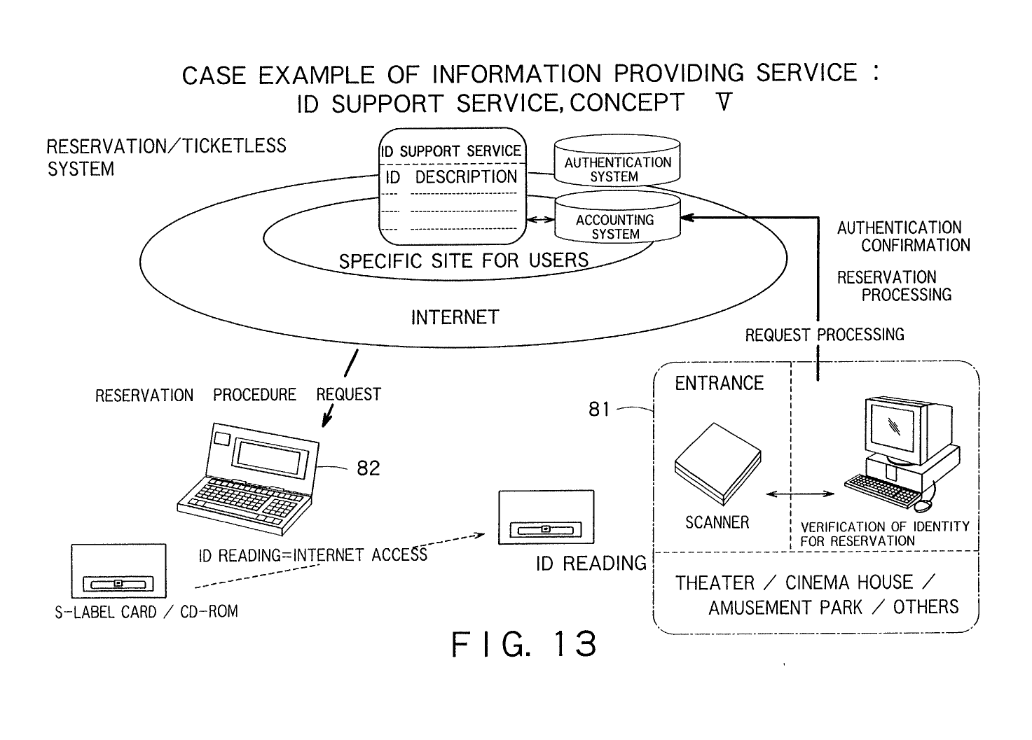

FIG. 12 is a block diagram showing a schematic structure of an IT system aiming at management of entering and dispatching from warehouse and inventory. In the IT system shown in FIG. 12, an arrival processing section (arrival status detecting means) 71, a shipment processing section (shipment status detecting means) 72, a stocktaking processing section (first inventory status comprehending means, second inventory status comprehending means and inventory determining means) 73 respectively have access to a specific site for users on the internet to transmit/receive information.

The arrival processing section 71 reads the S-label attached to an incoming good and transmits the read information to the specific site for users. Upon receiving the information from the arrival processing section 71, the specific site for users detects the arrival status and transmits arrival specification information to the arrival processing section 71. The arrival processing section 71 prints out an arrival specification slip based on the received arrival specification information.

The shipment processing section 72 reads the S-label attached to a shipment by the scanner 13 and transmits the read information to the specific site for users. Upon receiving the information from the shipment processing section 72, the specific site for users detects a shipment status and transmits shipment specification information to the shipment processing section 72. The shipment processing section 72 prints out a shipment specification slip based on the received shipment specification information.

The stocktaking processing section 73 reads the S-label attached to a stock good by the scanner 13 and checks an inventory status for each good. Further, the specific site for users detects the inventory status from the arrival status and the shipment status and transmits inventory specification information to the stocktaking processing section 73. The stocktaking processing section 73 compares the inventory status checked by itself and the inventory status transmitted from the specific state for users and obtains the accurate inventory status.

As described above, in this concrete example, since the arrival status and the shipment status are checked by using the S-label, the inventory status can be accurately obtained by the simple processing.

### FIFTH CONCRETE EXAMPLE

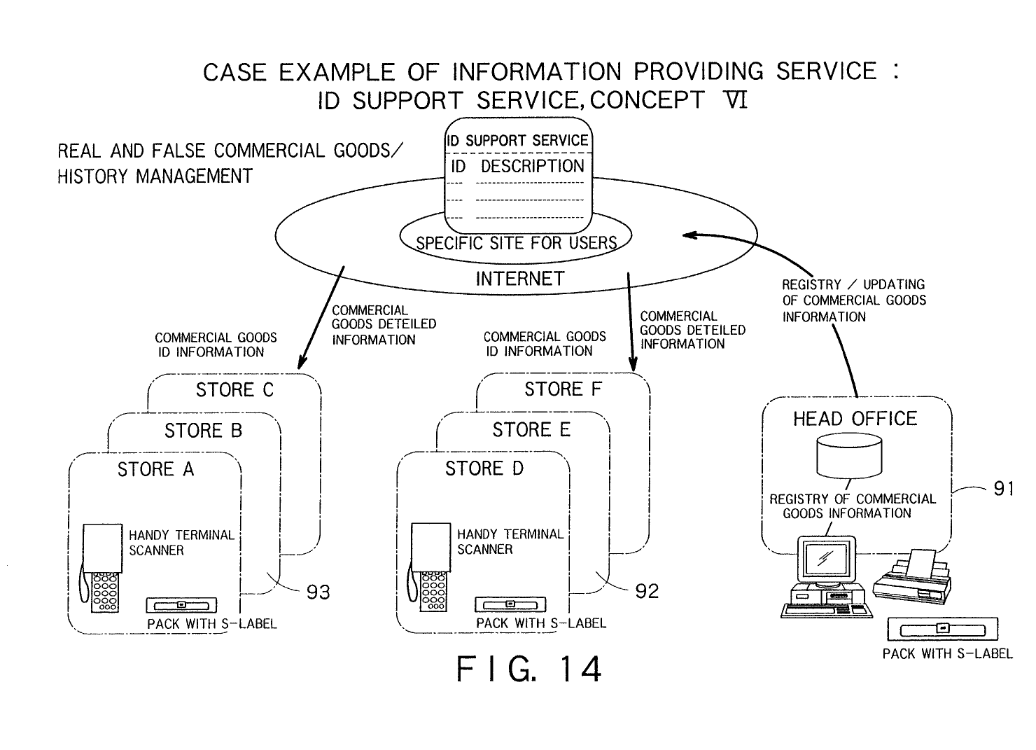

FIG. 13 is a block diagram showing a schematic structure of an IT system aiming at reservation and ticketless. The IT system in FIG. 13 gives the S-label on which identification information and personal information are recorded to each user and reads the information on the S-label by using the scanner 13 to automatically make a reservation for each of various events or transport facilities.

The IT system in FIG. 13 includes a reservation surrogate section (reservation accepting means and request processing means) 81 for making a reservation in accordance with a request for a reservation from a user and a home PC 82 by which the user him/herself makes a reservation. Both the reservation surrogate section 81 and the home PC 82 have access to the specific site for users on the internet to perform the reservation processing.

Both the reservation surrogate section 81 and the home P 82 read the S-label given to the user by the scanner 13 and transmit the read information to the specific site for users. The specific site for users carries out user authentication. When authentication has succeeded, this site accepts a reservation for an event and the like requested from the user and makes judgment upon whether the reservation is possible. If the reservation is possible as a result of judgment, the reservation processing is effected, and the user is then notified of information of securing a reservation through the reservation surrogate section 81 or the home PC 82. In this case, the request processing concerning the reservation is also carried out.

As described above, in this concrete example, since the personal information of the user is recorded in the S-label and the information on the S-label is read to conduct the reservation processing, the user can make a reservation for each of various events an the like without inputting his/her name and others, which saves the trouble of the user. Further, a reservation can be extremely rapidly made.

It is to be noted that the S-label may be recorded on a card type recording medium from which information can be read by a CD-ROM device. Consequently, data which exceeds an amount of data recorded on the S-label itself can be stored on one recording medium, and a sample screen, a menu screen or an online screen can be provided to the user.

### SIXTH CONCRETE EXAMPLE

FIG. 14 is a block diagram showing a schematic structure of an IT system aiming at real and false/history management of goods. The IT system in FIG. 14 includes a head office 91 which performs registry and updating of goods information and a plurality of stores 92 and 93 which make inquiries about the goods information. The head office 91 and the respective stores 92 and 93 have access to the specific site for users on the internet to transmit/receive the goods information.

The head office 91 reads the S-label of goods to be newly registered by the scanner 13 and transmits the read information to the specific site for users. The specific site for users constructs a database in which detailed information relating to each goods is recorded based on the information from the head office 91.

When the detailed information of goods (for example, the inventory status) is necessary, the stores 92 and 93 read the S-label of that goods by the scanner 13 and transmits the read information to the specific site for users to acquire the detailed information concerning that goods.

As described above, in the sixth concrete example, when there are goods whose detailed information is needed at a store, the detailed information of that goods can be acquired by only reading the S-label of that goods by the scanner 13 to be transmitted. Therefore, provision of the database at each store is no longer necessary, and the facility cost can be eliminated. In addition, even a person who is unfamiliar with the operation of the database can readily obtain the detailed information of the goods.

What is claimed is:

1. An IT (Information Technology) system comprising:
issuing and managing means for issuing and managing an RFID (Radio Frequency ID) having a unified data format;
an S-label on which the issued RFID is recorded;
reading means for reading data including said RFID recorded on said S-label;
authenticating means for authenticating said RFID read by said reading means; and
service providing means for providing various kinds of services to an owner of said S-label based on data read by said reading means when authentication by said authenticating means achieves success.

2. The IT system according to claim 1, further comprising transmitting means for transmitting, to said authenticating means, said RFID read by said reading means,
said issuing and managing means, said transmitting means, said authenticating means and said service providing means transmitting/receiving data to/from each other through a network.

3. The IT system according to claim 1, wherein said reading means transmits data read from said S-label to said transmitting means through a USB (Universal Serial Bus) interface.

4. The IT system according to claim 1, wherein said reading means transmits/receives said RFID in data read from said S-label by infrared data communication.

5. The IT system according to claim 1, wherein said S-label includes:
an RFID storage portion for storing said RFID;
a user storage portion for storing data inherent to each S-label; and
an electric wave transmission portion for transmitting data stored in said RFID storage portion and said user storage portion by wireless.

6. The IT system according to claim 1, wherein said reading means is a scanner having a card size.

7. The IT system according to claim 1, wherein said S-label is lent with or without charge for a predetermined period.

8. An IT system comprising:
issuing and managing means for issuing and managing an RFID having a unified data format with respect to each of commercial goods;
an S-label on which the issued RFID is recorded;
reading means for reading said S-label attached to each of commercial goods; and
information acquiring means for acquiring, from said issuing and managing means, information of commercial goods associated with said RFID read by said reading means.

9. An IT system comprising:
issuing and managing means for issuing and managing an RFID having a unified data format with respect to each of commercial goods;
an S-label on which the issued RFID is recorded;
reading means for reading data including said RFID recorded on said S-label;
a database recording therein information of commercial goods having said issued RFID; and
a store and a physical distribution center for making reference to said database,
said store and said physical distribution center respectively including said reading means to make reference to said database based on data of said S-label read by said reading means.

10. An IT system comprising:
issuing and managing means for issuing and managing an RFID having a unified data format with respect to each of commercial goods;
an S-label on which the issued RFID is recorded;
reading means for reading data including said RFID recorded on said S-label;
first transmitting means for reading said S-label of commercial goods ordered by a customer by said reading means and transmitting the read information to said issuing and managing means, when said commercial good arrives to each delivery center;
second transmitting means for reading said S-label of a commercial good ordered by a customer and transmitting the read information to said issuing and managing means, when said commercial good is delivered to said customer; and
shipment status providing means for providing, to a customer, a shipment status of commercial goods ordered by the customer in question based on information managed by said issuing and managing means, when said customer makes inquiries about the shipment status of said commercial good.

11. An IT system comprising:
issuing and managing means for issuing and managing an RFID having a unified data format with respect to each of commercial goods;
an S-label on which the issued RFID is recorded;
reading means for reading data including said RFID recorded on said S-label;
arrival status detecting means for detecting an arrival status based on a result of reading said S-label attached to each of incoming goods by said reading means;
shipment status detecting means for detecting a shipment status based on a result of reading said S-label attached to each of shipments by said reading means; and
first inventory status comprehending means for comprehending an inventory status based on a result of detection by said arrival status detecting means and said shipment status detecting means.

12. The IT system according to claim 11 further comprising:
second inventory status comprehending means for comprehending a stock status based on a result of reading said S-label of incoming goods and shipments by said reading means; and
inventory determining means for comparing the inventory statuses comprehended by said first and second inventory status comprehending means to determine a final stock.

13. An IT system comprising:
issuing and managing means for issuing and managing an RFID having a unified data format with respect to each user;
an S-label on which the issued RFID is recorded;
reading means for reading data including said RFID recorded on said S-label;
authenticating means for authenticating said RFID read by said reading means;
reservation accepting means for accepting a reservation from a user who owns said S-label, when authentication by said authenticating means achieves success; and
request processing means for performing accounting management concerning the accepted reservation,
said issuing and managing means, said authenticating means, said reservation accepting means and said request processing means transmitting/receiving data through a network.

14. An IT system comprising:
issuing and managing means for issuing and managing an RFID having a unified data format with respect to each of commercial goods;
a database recording therein information of the commercial goods having the issued RFID;
an S-label on which said RFID is recorded;
reading means for reading data including said RFID recorded on said S-label; and
retrieving means for looking up in said database based on a result of reading said S-label attached to each of commercial goods by said reading means to acquire information of a corresponding commercial goods.
